(19) United States
(12) Patent Application Publication
(10) Pub. No.: US 2013/0105746 A1
(43) Pub. Date: May 2, 2013

(54) INSULATION MATERIAL CONTAINING MICROFIBERS FROM STEM FIBERS OF BANANA FRUIT TREES

(71) Applicants: Fabrice Carpanzano, Allauch (FR); Jérôme Carpanzano, Marseille (FR); Laetitia Carpanzano, Allauch (FR); Béatrice Orsini, Marseille (FR)

(72) Inventors: Fabrice Carpanzano, Allauch (FR); Jérôme Carpanzano, Marseille (FR); Laetitia Carpanzano, Allauch (FR); Béatrice Orsini, Marseille (FR)

(21) Appl. No.: 13/697,102

(22) PCT Filed: May 9, 2011
(86) PCT No.: PCT/FR2011/000281

§ 371 Date: Jan. 2, 2013

(30) Foreign Application Priority Data
May 11, 2010 (FR) 1053652

(51) Int. Cl. E04B 1/88; C09K 21/14

(52) U.S. Cl. CPC E04B 1/88; C09K 21/14
USPC 252/601; 252/62; 264/299; 427/384; 47/48.5; 47/9

(57) ABSTRACT

The invention relates to a material used as thermal and/or sound insulation material, consisting essentially of microfibers from stem fibers of banana fruit trees. Said material has surprising sound and thermal insulation properties, and more particularly heat and cold resistance properties.

### TECHNICAL FIELD OF THE INVENTION

An object of the present invention is a thermally and/or acoustically insulating material essentially comprising plant microfibers from fibers of stems of banana fruit trees. An obect is also various uses of this material as well its process of manufacture.

The technical field of the invention is that of the manufacture of building materials based on plant fibers, in particular materials used as thermal and/or acoustic insulation for construction of houses and industrial premises, for the automotive industry, industrial vehicles, aircraft and/or spatial or the containment of materials or walls brought to very high or very low temperatures. It also relates to the technical field of materials used for the hydration and the cultivation of plants.

### PRIOR ART

Building insulating materials based on plant fibers such as hemp or cotton fibers as well as coconut, palm, or Abaca (Manila hemp) fibers are known.

Hemp fibers constitute good thermal and acoustic insulators, completely natural and therefore easily recyclable. However, their production requires ungainly means; in effect, it is necessary to cultivate the hemp, harvest it, then extract the fibers before forming them.

The cotton wools have the advantage of being producable from recycled cotton fibers obtained for example by unravelling of old fabrics, cleaning and compacting of the fibers. Nevertheless, theses cotton wools are expensive and have a very low mechanical strength.

Finally, insulators based on coconut, palm or Abaca fibers are very expensive and require ungainly means to perform the extraction and treatment of fibers.

Also known in the prior art are insulating materials based on plant fibers from banana tree.

The patent document FR 2,846,685 (CARPANZANO, Joseph) describes for example a board constituted essentially by fibers of dried banana skins. The document WO 2005/092985 (CARPANZANO, Joseph) also describes a material based on plant fibers constituted essentially by chips of banana skins and/or banana trees.

The patent document FR 2,583,743 (FRESSON) discloses a lightweight concrete based on agricultural residues, such as banana tree trunks, treated to obtain fibers interlacing with the mixture, in mixture with a hydraulic binder.

The patent document NL 63,937 (KOOL) discloses the use of residues of bananas bunches, cut and pressed to remove the juice, then dried and finally divided into fibrous particles. The latter are mixed with a binder to be used in a construction material.

The article W. KILLMANN ET AL: “Verwertungsmôglichkeiten der Bananfasern” DEUTSCHE PAPIERWIRTSCHAFT, Vol. 1977, No. 3, 1977, pages 61-65, describes the use of fibererous parts of banana tree, after grinding, noteably for the manufacture of insulating materials.

The insulating materials described in these documents all have acceptable insulating properties.

The main objective of the invention is to provide a new material that exhibits properties of thermal insulation and acoustic insulation superior to those obtained with materials based on plant fibers from banana trees.

Another objective of the invention is to provide a method enabling simple, quick manufacture and at low cost of this insulating material.

### DISCLOSURE OF THE INVENTION

The solution offered by the invention is a material used as thermal and/or acoustic insulation, constituted essentially by microfibers from fibers of banana fruit tree stems.

This material has thermal and acoustic insulation properties far superior to known insulation materials, especially compared to other materials using fibers from banana skins, trunks, pseudo-trunks or stems of banana trees, and that at both positive and negative temperatures. The applicant has in fact found that fibers from banana tree stems have surprising acoustic and thermal insulation properties, especially properties of resistance to heat and cold.

By “microfibers” is meant, in the sense of the present invention, fibers having a diameter between 0.01 mm and 1 mm, and preferably of the order of 0.1 mm.

By “banana fruit trees”, is meant noteably all kinds and species of banana trees grouped under the taxonomic genus Musa of the family of Musaceaes.

By “banana tree stems” is meant, in the sense of the present invention, the arch-shaped rods pointed downwards, which emerge from the top of banana trees and that bear bananas.

Applicants found that banana fruit tree stems are composed almost entirely of fibers having the property of dividing into microfibers, while the fibers of other parts of the banana tree are unique and indivisible or difficultly divisible. However, these microfibers, when they are agglomerated, have the ability to store a large volume of air microbubbles that contribute to the thermal and acoustic insulation of the final material. The applicants were able to demonstrate that the volume of air stored in an agglomerate of microfibers from stems of banana tree fibers is higher (from 5% to 30% depending on the density of the finished material) to the volume of air stored in an agglomerate of single fibers from other parts of the banana tree (stem, pseudo-stem, leaves, banana peels, . . . ). It follows that the material object of the invention has properties of thermal and acoustic insulation superior to those materials based on fibers from other parts of the banana tree and known in the prior art.

In order to maximize agglomeration of the microfibers and to store more air microbubbles, the aforementioned microfibers are advantageously mixed with a fibererous binder.

The insulating material is advantageously constituted by at least 80%, preferably at least 90%, of microfibers from fibers of banana fruit tree stems.

According to a preferred implementation mode the insulating material is in the form of boards, rolls or microfibers to be blown or flocked.

Another aspect of the invention relates to a method of manufacturing the insulating material. This method comprises:
unravelling stems of banana fruit trees so as to separate the fibers of the aforementioned stems into microfibers,
crushing the obtained microfibers in order to flatten them then and unravel them again.

Microfibers having a minimal diameter are thus obtained.

Advantageously, the microfibers obtained are mixed with a binder; this mixture is introduced into molds, templates, or glazing tools; and this mixture is heated to provide the final shape of the material.

Before or during the mixing of the microfibers with the binder, the aforementioned microfibers can undergo a fire retardant and/or antibacterial and/or fungicidal treatment.

To increase the volume of air stored in the material and increase the insulating properties of the latter, the microfibers are preferably mixed with aluminum oxide and potassium to generate hydrogen microbubbles. After introducing the mixture into the molds, templates or glazing tools, the aforementioned mixture is heated in order to replace the aforementioned hydrogen microbubbles by air microbubbles.

In an an implementation mode variant, the microfibers are mixed with a binder and optionally with water, to obtain a pasty mixture. The latter is then mixed with aluminum oxide and potassium, so as to form hydrogen microbubbles. The resulting pasty product is then coated onto a substrate and then heated so as to replace the hydrogen microbubbles by air microbubbles.

Yet another aspect of the invention relates to the use of insulating material, for hydration and the cultivation of plants, in the form of boards or rolls adapted to be applied on, or buried in, the soil of the terrain to be cultivated.

Yet another aspect of the invention relates to the use of the insulating material as mulch, the microfibers being applied loose to the base of plants in order to limit evaporation and/or the growth of weeds and/or as thermal protection.

Other aspects of the invention relate to the use of insulating material:
as a flame retardant, in the form of boards, rolls, adapted to be being applied onto at least one other material to be fireproofed,
as a filtering agent, being preferably embedded in a membrane, a filter or any other equivalent filtration device,
for the making of post-formed products such as casing, smart card, circuit board.

Other advantages and features of the invention will better appear upon reading the description that is going to follow, made way of indicatif and non-limiting example.

### IMPLEMENTATION MODES OF THE INVENTION

The material object of the invention is made from agglomerated microfibers fibers of stems of banana fruit tree. These stems can be used in their natural state as raw material, without requiring treatments or extractions. This enables siginficant limitation of the production costs of material, but it is also completely natural and thus fully and easily recyclable. The microfibers obtained can optionally undergo a fire retardant and/or antibacterial and/or fungicidal treatment, but this is not necessary.

The material consists essentially of agglomerated or non-agglomerated microfibers from fiber stems of banana fruit tree, that is to say consisting of at least 50% of microfibers, advantageously at least 80% of agglomerated microfibers, preferably at least 90%, and 100% if necessary. Such a proportion gives the material a very low toxicity to the environment, and a very good recyclability, even when the microfibers are mixed with a binder. In addition, it greatly reduces the costs of raw material and therefore of production of the material.

In practice, the diameter of microfibers is between approximately 0.01 mm and 1 mm, and in practice of the order of 0.1 mm following the technique of pushed unravelling described hereinafter in the later in the description.

The microfibers can be used as is or agglomerated by a simple compaction. However, they are advantageously densified in order to improve the mechanical strength of the material. In practice, the microfibers are mixed with a binder that provides cohesion and improves their agglomeration. The material obtained is thus more rigid, with a higher mechanical strength, easier to shape and easily handable. The binder selected can be a dry fibrous binder, optionally synthetic of the polypropylene type, or an aqueous organic binder such as a paste based on starch or cellulose paste, or an aqueous inorganic binder such as a hydraulic binder based on sodium silicate (Na₂SiO₃).

The fibreous microfibers/binder mixture has the advantage of being able to store a large amount of air microbubbles and thus increase the thermal and acoustic insulation capacities of the material.

Other suitable components and additives suitable to the person of skill in the art can be combined with the microfibers depending on uses of the material of the invention.

The extremely simple constitution of the material of the invention enables a packaging, formatting, and storage in various forms, which are more particularly chosen depending on applications. The material is, however, preferably in the form of boards or rolls of varying dimensions, density and thicknesses. The material can also be in the form of sleeves, tubes, plates, sheets, fleeces (by trapping of a layer of material between two sheets of at least one flexible material and preferably flame retardant, in particular at least a textile material), etc. In general, it is possible to obtain rigid, semi-rigid or flexible elements, and at least keep their shape. It can also be used in the raw state, loose, for hydration and the cultivation of plants, for example by mixing microfibers with earth or compositions for hydration and cultivation of plants or in soilless hydroponic culture. The microfibers can also be used directly as mulch. The microfibers are also suitable for coating applications by machine or hand flocking, blowing or by molding or over molding on complex parts of machines, thermal or mechanical, among others.

The material has surprising properties of thermal insulation, acoustic insulation, fire retardance and liquid absorption.

With regard to the thermal insulation properties, tests demonstrated that a duct having a thickness between 0.5 cm and 1 cm constituted by the insulating material, applied to an exhaust duct of a boiler producing a stream of hot air with a temperature of approximately 300° C., enables full insulation of the aforementioned duct. The temperature rise on the external surface of the duct in contact with air is very low, a few degrees, which allows manual contact on the aforementioned duct without impression of heat or burns, even during prolonged contact of several tens of seconds.

In addition, tests for measuring the thermal coefficient conductivity were used to determine that the material has thermal insulation properties better than those obtained with the material described in the document WO 2005/092985 (CARPANZANO Joseph), with values of thermal coefficient conductivity (A) of less than 0.041 W/m·K, on the order of approximately 0.038 W/m·K, and in all cases lower than the coefficients of thermal conductivity of the insulating materials of plant origin currently on the market.

The material can therefore be used, in a non-limiting manner, to achieve containment of boiler or fireplace conduits, hot water tanks for individuals or professionals, in the aerospace and automotive industry for containment of thermal motors, exhaust ducts or the like. The material of the invention also enables implementaiotn of insulation devices for chilling such as cold rooms, refrigerators, refrigerated trucks and cars.

The material can also be used in the form of filler, plating or coating on or against another material to be insulated such as gypsum (type BA10, BA13) or wood, for example, or an insulating layer embedded between at least two of the aforementioned boards of another material. It is also possible, in particular for containment or caulking applications to form a batt constituted essentially by a thickness of material according to the invention, preferably agglomerated without binder, embedded between two sheets or layers of at least one flame retardant textile.

With regard to the acoustic insulation properties, tests measuring the acoustic absorption coefficient with the impedance tube made in accordance with the standard DIN EN ISO 10534-1 and 2 were used to determine that the material has acoustic insulation properties better than those obtained with the material described in the patent document WO 2005/092985 (CARPANZANO Joseph), with absorption coefficient values at medium frequencies greater than 0.9.

The material can thus be used as acoustic insulation, for example of ceiling tiles, in the form of boards, plates, or sheets, flannels, rolls or fillers, and under the same conditions set out above.

With regard to flame retardancy, the fibers of banana tree stems are almost a natural self-extinguishing flame retardant making the material nonflammable. Thus, a plate having a thickness of 3 cm formed by a glaze of microfibers agglomerated with a binder based on sodium silicate on which is applied a flame for a period of 30 minutes does not catch fire and visual degradation is not apparent. It is also noted that there is a lack of red point (or melting point), the microfibers not being consumed. The material thus requires no, or little, fireproofing treatment of the microfibers in order to prevent or delay the phenomena of surface carbonization of the material subjected to prolonged contact with flames.

In this application, the material can be used in the form of boards or rolls applied to at least one other material to be fireproofed. In particular, the material can be used in plating or coating, for making doors and fire separations or for the containment of automotive interiors. Microfibers can also be directly flocked or blown onto at least one other material to be fire proofed.

With regard to other properties of the material according to the invention, tests showed that a plate of such a material was able to absorb a liquid volume at least equal to its own volume. Such absorption properties, combined with thermal insulation properties, make it a very good retainer of liquids. This allows in particular maintainability, for example in crop applications, of a high level of humidity for a long time (at least one week) in the absence of watering, allowing for example a water-saving during periods of heat, but also retaining water in the land and preventing frost around the roots of plants in winter. The material can also be used as mulch, the microfibers being directly applied loose to the base of plants to reduce evaporation and/or weed growth and/or as thermal protection.

As an absorbent, the material can be used in the form of boards or rolls, adapted to be applied on, or buried in, the soil of the terrain to be cultivated. In practice, a board is provided having approximately 2 cm thickness that is buried a few centimeters form the surface. Such use also limits the growth of weeds. The microfibers can also be mixed directly in potting soil.

The process of manufacture of the material will now be described in more detail. First the stems of banana fruit tree are collected in the natural state, without being treated or prepared beforehand. The stems of banana tree produce, that are cut after harvest of bunches of banana can be directly used.

These stems are unravelled in order to separate the fibers into microfibers. In practice, the stems pass in a tearing machine whose needles open the fibers to reveal the microfibers. Microfibers having a diameter of approximately 0.5 mm to 1 mm, which are recovered at the outlet of the tearing machine in the form of a crude mixture constituted by the aforementioned microfibres and substances contained in liquid form in the stems such as water and starch, among others.

After the unraveling, it can be advantageous to remove the majority of these liquid substances. To do this, the obtained residual mixture is pressed at the outlet of the tearing machine, using a hydraulic press under a pressure between 200 kg/cm² and 400 kg/cm². Preferably, the residual mixture is pressed between pressing dies heated to a temperature of approximately 100° C. to 120° C., which enables carrying out a superficiel pre-drying of the microfibers.

After having unravelled the stems of the banana tree a first time, and optimally after pressing the residual mixture, the microfibers obtained can be crushed between two rolls so as to flatten them in order to unravel them a second time. Indeed, the crushing of the microfibers increases their surface such that the needles of the tearing machine can divide them again. It is then possible to obtain smaller microfibers, having a diameter on the order of 0.1 mm.

Depending on the applications, these microfibers can be used as is or, to the contrary, agglomerated by a simple press compaction or mixed with a binder, and optionally water, which provides their cohesion and improves their agglomeration.

The binder selected can be a fiberous binder of the polypropylene type. The microfiber/fiberous binder mixture has the advantage that it can store a large amount of air microbubbles and thus increase the thermal and acoustic insulation capacities of the material.

An aqueous organic binder can also be used such as a starch-based paste or a cellulosic paste.

An inorganic aqueous binder can be used such as an hydraulic binder based on sodium silicate (Na₂SiO₃), in particular a binder containing 20% to 40% sodium silicate to 60% to 80% water and known by chemical name of neutral liquid sodium silicate. This aqueous binder is in the form of a viscous colorless liquid, enabling easy mixing with the microfibers, which solidifies with air and heat and which has the essential advantages of being non-flammable and non-combustible (Euroclasses A1 and A2), having very little toxidity and easily recyclable. Such a binder is for example produced and marketed respective by the Belgian companies SILMACO N. V. and BRENNTAG N. V. under the reference Silicate Soda 38/40.

The percentage of binder can vary depending on the nature of the latter, the desired final density, applications and properties sought. For this purpose, the microfibers with a small amount of binder are mixed in a mixer, in order to form a mixture with a content of at least 80%, and preferably at least 90%, microfiber and at most 20%, preferably at most 10% of binder. This mixture is then introduced into molds, templates or glazing tools and pressed. The assembly is heated at a temperature of on the order of 100° C. to 300° C., for several minutes to provide the final shape of the material. When fibrous binder is used, the temperature rise of the mixture melts the fibrous binder which then blends intimately with the microfibers. The latter are then completely agglomerated after cooling.

The material can also be shaped in shaping molds, if need be in veneer or in admixture with thermoplastic materials for making automotive dashboards and gaskets.

Before or during the mixing of the microfibers with the binder, the aforementioned microfibers can undergo a fire retardant and/or antibacterial and/or fungicidal treatment. In practice, the microfibers are soaked in tubs containing flame proofing, antibacterial and/or fungicidal agents.

In order to increase the volume of air stored in the material and increase the insulating properties of the latter, the microfibers can be mixed with aluminum oxide and potassium so a to generate hydrogen microbubbles. This mixing can be carried out before, during or after mixing with the binder and prior to heating. After having introduced the mixture into the molds, templates or glazing tools, the aforementioned mixture is heated in an oven or a stems room, the hydrogen microbubbles being replaced by air microbubbles under the effect of heat.

The microfibers can also be mixed, for example by stirring, with a binder and optionally with water, to obtain a pasty mixture. This mixture is then mixed with the aluminum oxide and potassium, so as to form hydrogen microbubbles. The resulting pasty product can then be coated onto a support and then heated by means of a heat gun type heating apparatus, so as to replace the hydrogen microbubbles by air microbubbles.

The boards and sheets of material thus made are then removed from the mold and can be conserved and stored as is, or in the form of rolls, for their future use, or cut to particular formats, such as tiles or boards of standard sizes. If necessary they can also be subjected to a post-treatment against rot or be coated to improve their appearance and especially their mechanical strength or intrinsic absorption or insulation as well as fire resistance proprieties.

This material essentially comprising plant microfibers from stems of banana fruit tree fibers can be used in many other applications.

It can noteably be used as a filtering agent for air, water and other contaminated fluids. This material in fact has properties of absorption and/or retention of pollutant agents, for example those present in the air or in a liquid such as mercury, lead (heavy metals), medical waste, organic waste, etc.

Applicants found that the plant microfibers from stem fibers of banana fruit tree have the capacity to capture a large volume of pollutant agents. Indeed, microfibers have the advantage of capacity being able to store a large quantity of air microbubbles and thus increase the absorption and/or retention capacities of the material.

According to a preferred implementation mode the filter material is embedded in a membrane, a filter or any other filtration device.

The microfibers can be used as is or agglomerated by a simple compaction in a filter or filter membrane. However, they are advantageously densified in order to improve the mechanical strength of the material. The microfibers can be mixed with a binder that provides their cohesion and improves their agglomeration. The binder used is preferably of clay, which is a natural material with odor capturing properties. Once the microfibers and clay are combined and shaped for filtration applications, the properties of absorption and/or retention of pollutant agents are optimized. This same mixture can obviously be used for other applications and in particular as thermal and/or acoustic and/or fireproofing insulator, etc.

In order to increase the volume of air stored in the material and increase the absorption and/or retention properties of the latter, the microfibers and the clay can be mixed with aluminum oxide and potassium to generate hydrogen microbubbles. This mixing can be effected before, during or after mixing with the binder and prior to heating. After having introduced the mixture into molds, templates or glazing tools, the aforementioned mixture is heated in an oven or a stem room, the hydrogen microbubbles being replaced by air microbubbles under the effect of the heat.

Yet another application comprises using these microfibesr to making casing, smart card, circuit board, or any other postformed product used in the sector of automotive, telephony, computing (smart card, circuit board . . . ). In this application, the microfibers are mixed with binders of the synthetic plastic or polyethylene, or polyester and starch type, etc.

1. Thermal and/or acoustic insulating material, characterized in that it constituted essentially by microfibers from fibers of banana fruit tree stems.

2. Material according to claim 1, characterized in that the microfibres are mixed with a fiberous binder.

3. Material according to claim 1, characterized in that it is constituted by at least 80% agglomerated microfibers from fibers of banana fruit tree stems.

4. Material according to claim 1, characterized in that it is in the form of boards, rolls, or of microfibers to be blown or to be flocked.

5. Method for manufacturing of the material according to claim 1, comprising:
unravelling stems of banana fruit trees so as to separate the fibers of the aforementioned stems into microfibers,
crushing the obtained microfibers in order to flatten them then and unravel them again.

6. Method of claim 5 comprising:
mixing the obtained microfibers with a binder,
introducing the mixture into molds, templates or glazing tools,
heating the mixture to provide the final shaping of the material.

7. Method according to claim 6, wherein before or during the mixing of the microfibers with the binder, the aforementioned microfibers undergo a fire retardant and/or antibacterial and/or fungicidal treatment.

8. Method according to claim 6, wherein:
the microfibers are mixed with aluminum oxide and potassium so as to generate hydrogen microbubbles,
after having introduced the mixture into the molds, templates or glazing tools, the aforementioned mixture is heated to replace the aforementioned hydrogen microbubbles by air microbubbles.

9. Method according to claim 5, wherein:
the microfibers are mixed with a binder and optionally with water, in order to obtain a pasty mixture,
the pasty mixture is mixed with aluminum oxide and potassium, so as to form hydrogen microbubbles,
the resulting pasty product is coated onto a substrate and then heated so as to replace the hydrogen microbubbles by air microbubbles.

10. Use of the material according to claim 1, for the hydration and the cultivation of plants, in the form of boards or rolls adapted to be applied onto, or buried in, the soil of the terrain to be cultivated.

11. Use of the material according to claim 1, as mulching, the microfibers being applied loose to the base of plants in order to limit evaporation and/or the growth of weeds and/or as thermal protection.

12. Use of the material according to claim 1, as a flame retardant, in the form of boards, rolls, or microfibers to be blown or to be flocked adapted to be being applied onto another material to be fireproofed.

13. Use of the material according to claim 1 as a filtering agent.

14. Use according to claim 13, characterized in that the material is embedded in a membrane, a filter or any other equivalent filtration device.

15. Use of the material according to claim 1, for the making of post-formed products such as casing, smart card, circuit board.
